(19) United States
(12) Patent Application Publication
(10) Pub. No.: US 2025/0080206 A1
(43) Pub. Date: Mar. 6, 2025

(54) SYSTEMS AND METHODS FOR DETERMINING LOCATION SUITABILITY FOR SATELLITE COMMUNICATION

(71) Applicant: Hughes Network Systems, LLC, Germantown, MD (US)

(72) Inventors: Pranav Singh, Alpharetta, GA (US); Mahesh Kagitha, Clarksburg, MD (US); Amarender Singh Sardar, Aldie, VA (US); Vedant Desai, Germantown, MD (US)

(21) Appl. No.: 18/501,181

(22) Filed: Nov. 3, 2023

Related U.S. Application Data
(60) Provisional application No. 63/579,343, filed on Aug. 29, 2023.

(51) Int. Cl. H04B 7/185; G06T 19/00

(52) U.S. Cl. CPC H04B 7/18513; G06T 19/006

(57) ABSTRACT

Various arrangements for determining location suitability for satellite communication are presented herein. A mobile device can install an augmented reality (AR) application to output, via a display of the mobile device, a user interface depicting a field of view being captured by a camera of the mobile device. The AR application can capture, via the camera, one or more frames of an overhead area that collectively map a 360-degree representation of the overhead area. The one or more frames can be used to determine that continuous communication with a satellite constellation is available. The AR application can output, via the display, an obstruction map based on the one or more frames that indicates open sky available for communication with the satellite constellation.

### CROSS-REFERENCES TO RELATED APPLICATIONS

This application claims the benefit of and priority to U.S. Provisional Application No. 63/579,343, filed on Aug. 29, 2023, which is hereby incorporated by reference in its entirety.

### BACKGROUND

Determining a suitable location to install an antenna for an end user terminal for satellite communication (e.g., satellite-based internet connections) can be difficult due to lack of awareness with respect to open sky available for communication with a satellite constellation. Obstructions (such as trees, buildings, etc.) may interfere with an ability of the end user terminal to maintain continuous communication with the satellite constellation. Re-installing the antenna for the user terminal after determining that communication with the satellite constellation is hindered or unavailable can be tedious and time-consuming.

### SUMMARY

In some embodiments, systems for determining that continuous communication with a satellite constellation is available are presented herein. A system can include a mobile device that can include a non-transitory processor readable medium, a display, one or more processors, and a camera. An augmented reality (AR) application can be installed on the mobile device. The AR application can be configured to output, via the display of the mobile device, a user interface depicting a field of view being captured by the camera. The AR application can be configured to capture, via the camera of the mobile device, a plurality of frames of an overhead area through which the continuous communication with the satellite constellation is to be provided. The plurality of frames can collectively map a 360-degree representation of the overhead area. The AR application can be configured to determine that the continuous communication with the satellite constellation is available using the plurality of frames. The AR application can be configured to output, via the display, an obstruction map based on the plurality of frames that indicates open sky available for communication with the satellite constellation.

Embodiments of such a system can include one or more of the following features: The AR application can be further configured to: determine a recommendation with respect to installing an antenna for a user terminal based on a predefined threshold with respect to the open sky available for communication with the satellite constellation; and output, via the user interface, the obstruction map, wherein the obstruction map comprises a visual indicator associated with the open sky available for communication with the satellite constellation and the recommendation. The predefined threshold with respect to the open sky available for communication with the satellite constellation can be independent of an orientation of the antenna. Determining that the continuous communication with the satellite constellation is available can further comprise executing a machine-learning model to: identify a block region of the plurality of frames, wherein the block region comprises a plurality of pixels; determine that at least one pixel of the plurality of pixels includes an obstruction by performing image segmentation; and assign an obstruction identifier to the block region associated with the at least one pixel, wherein the obstruction identifier indicates that the overhead area corresponding to the block region is obstructed. The AR application can be further configured to, prior to capturing the plurality of frames of the overhead area: output an elevation indicator overlaying the user interface, wherein the elevation indicator is configured to indicate a predefined angle at which to tilt the mobile device prior to capturing the plurality of frames of the overhead area; and, subsequent to the mobile device being tilted at the predefined angle, provide, via the user interface, an interface element configured to be selected to initiate the capturing step. Capturing the plurality of frames can further comprise: outputting, via the user interface, one or more graphical elements overlaying the field of view, wherein an amount of the one or more graphical elements is configured to indicate progress of the capturing step; capturing a particular frame of the plurality of frames, wherein the particular frame corresponds to a subset of the one or more graphical elements; in response to capturing the particular frame, removing a subset of the one or more graphical elements from the user interface; and outputting a progress indicator corresponding to the subset of the one or more graphical elements removed from the user interface. The obstruction map can further comprise a two-dimensional representation of the overhead area, azimuthal identifiers with respect to the two-dimensional representation, and cardinal direction indicators with respect to the two-dimensional representation, and wherein the two-dimensional representation includes a visual indicator configured to indicate a respective location of obstructions detected in the overhead area.

In some embodiments, methods for determining location suitability for satellite communication are presented herein. The method can include: using an augmented reality (AR) application installed on a mobile device to: output, via a display of the mobile device, a user interface depicting a field of view being captured by a camera of the mobile device; capture, via the camera of the mobile device, a plurality of frames of an overhead area through which the continuous communication with the satellite constellation is to be provided, the plurality of frames collectively mapping a 360-degree representation of the overhead area; determine that the continuous communication with the satellite constellation is available using the plurality of frames; and output, via the display, an obstruction map based on the plurality of frames that indicates open sky available for communication with the satellite constellation.

Embodiments of such a method can include one or more of the following features: The method can include using the AR application to: determine a recommendation with respect to installing an antenna for a user terminal based on a predefined threshold with respect to the open sky available for communication with the satellite constellation; and output, via the user interface, the obstruction map, wherein the obstruction map comprises a visual indicator associated with the open sky available for communication with the satellite constellation and the recommendation. The predefined threshold with respect to the open sky available for communication with the satellite constellation can be independent of an orientation of the antenna. Determining that the continuous communication with the satellite constellation is available can further comprise executing a machine-learning model to: identify a block region of the plurality of frames, wherein the block region comprises a plurality of pixels; determine that at least one pixel of the plurality of pixels includes an obstruction by performing image segmentation; and assign an obstruction identifier to the block region associated with the at least one pixel, wherein the obstruction identifier indicates that the overhead area corresponding to the block region is obstructed. The machine-learning model can be configured to be retrained using an updated training dataset, and wherein the updated training dataset includes at least one frame of the plurality of frames captured during the capturing step. The AR application can be further configured to, prior to capturing the plurality of frames of the overhead area: output an elevation indicator overlaying the user interface, wherein the elevation indicator is configured to indicate a predefined angle at which to tilt the mobile device prior to capturing the plurality of frames of the overhead area; and subsequent to the mobile device being tilted at the predefined angle, provide, via the user interface, an interface element configured to be selected to initiate the capturing step. Capturing the plurality of frames can further comprise: outputting, via the user interface, one or more graphical elements overlaying the field of view, wherein an amount of the one or more graphical elements is configured to indicate progress of the capturing step; capturing a particular frame of the plurality of frames, wherein the particular frame corresponds to a subset of the one or more graphical elements; in response to capturing the particular frame, removing a subset of the one or more graphical elements from the user interface; and outputting a progress indicator corresponding to the subset of the one or more graphical elements removed from the user interface. The obstruction map can further comprise a two-dimensional representation of the overhead area, azimuthal identifiers with respect to the two-dimensional representation, and cardinal direction indicators with respect to the two-dimensional representation, and wherein the two-dimensional representation includes a visual indicator configured to indicate a respective location of obstructions detected in the overhead area.

According to another set of embodiments, a computational system is provided. The computational system can include a set of processors and a non-transitory memory having instructions stored thereon, which, when executed, cause the set of processors to perform steps using an AR application installed on a mobile device. The steps can include: outputting, via a display of the mobile device, a user interface depicting a field of view being captured by a camera of the mobile device; capturing, via the camera of the mobile device, a plurality of frames of an overhead area through which the continuous communication with the satellite constellation is to be provided, the plurality of frames collectively mapping a 360-degree representation of the overhead area; determining that the continuous communication with the satellite constellation is available using the plurality of frames; and outputting, via the display, an obstruction map based on the plurality of frames that indicates open sky available for communication with the satellite constellation.

Embodiments of such a computational system can include one or more of the following features: The steps can further comprise using the AR application to: determine a recommendation with respect to installing an antenna for a user terminal based on a predefined threshold with respect to the open sky available for communication with the satellite constellation; and output, via the user interface, the obstruction map, wherein the obstruction map comprises a visual indicator associated with the open sky available for communication with the satellite constellation and the recommendation. The predefined threshold with respect to the open sky available for communication with the satellite constellation can be independent of an orientation of the antenna. Determining that the continuous communication with the satellite constellation is available can further comprise executing a machine-learning model to: identify a block region of the plurality of frames, wherein the block region comprises a plurality of pixels; determine that at least one pixel of the plurality of pixels includes an obstruction by performing image segmentation; and assign an obstruction identifier to the block region associated with the at least one pixel, wherein the obstruction identifier indicates that the overhead area corresponding to the block region is obstructed. The steps can further comprise using the AR application to, prior to capturing the plurality of frames of the overhead area: output an elevation indicator overlaying the user interface, wherein the elevation indicator is configured to indicate a predefined angle at which to tilt the mobile device prior to capturing the plurality of frames of the overhead area; and subsequent to the mobile device being tilted at the predefined angle, provide, via the user interface, an interface element configured to be selected to initiate the capturing step.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a mobile device that determines whether continuous communication of an antenna with a satellite constellation is available.

FIG. 2 illustrates an embodiment of a satellite communication system including an antenna communicatively coupled with a satellite constellation.

FIG. 3 illustrates an embodiment of a block region of a frame captured by a mobile device.

FIG. 4 illustrates an embodiment of an obstruction map outputted via a user interface of a mobile device.

FIG. 5 illustrates an embodiment of a user interface to guide an operator when obtaining visual data of an overhead area associated with installing an antenna for a user terminal.

FIG. 6 illustrates another embodiment of a user interface to guide an operator when obtaining visual data of an overhead area associated with installing an antenna for a user terminal.

FIG. 7 illustrates an embodiment of a user interface when obtaining visual data of an overhead area associated with installing an antenna for a user terminal is in progress.

FIG. 8 illustrates an embodiment of a user interface when obtaining visual data of an overhead area associated with installing an antenna for a user terminal is completed.

FIG. 9 illustrates an embodiment of a method for generating an obstruction map based on an availability of continuous communication with a satellite constellation.

### DETAILED DESCRIPTION

A satellite meter can be used to measure a signal strength of communication with satellites of a satellite constellation to determine whether a particular location is suitable to install an antenna for an end user terminal. But, using the satellite meter may require an operator to access hazardous environments (e.g., a rooftop, side of a building, etc.) to establish a wired connection of the satellite meter to the end user terminal. In contrast, a mobile application with augmented reality (AR) and machine learning capabilities can be used to determine whether continuous communication with a satellite constellation, which can be in low Earth orbit (LEO) or medium Earth orbit (MEO), is available.

The mobile application can output a user interface that uses AR to guide the operator through a series of steps to collect visual data of an overhead area at a possible installation location. The mobile application can be installed on a portable mobile device, such as a smartphone or tablet computer, thereby potentially enabling the operator to limit exposure to the hazardous environments. Using the visual data, the mobile application can execute a machine-learning model trained to perform semantic segmentation to determine whether obstructions that interfere with the signal strength are present based on the visual data. Based on the output from the machine-learning model, the mobile application can output a recommendation of whether to proceed with installing the antenna for the end user terminal. Additionally or alternatively, the mobile application can output an obstruction map to visualize the overhead area and areas of obstruction, enabling more informed decision-making with respect to installing the antenna for the end user terminal. Such improvements can result in a faster and more accurate installation process for the antenna of the end user terminal. As an example, the machine-learning model can process the visual data of the overhead area to detect if obstructions are present and to quantify open sky available for continuous communication with the satellite constellation.

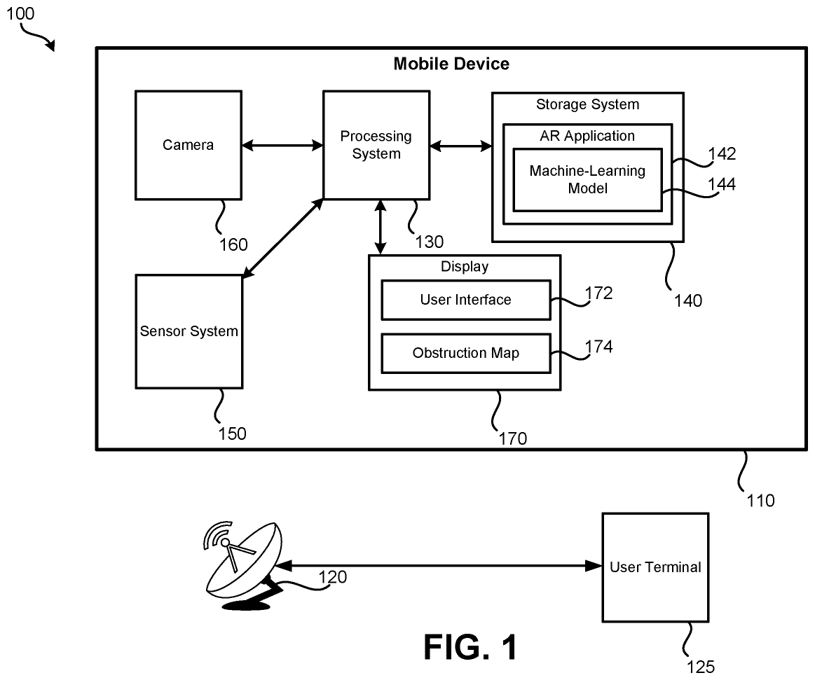

Further detail regarding the above embodiments and other embodiments is provided in relation to the figures. FIG. 1 illustrates a block diagram of an embodiment 100 of a mobile device 110 to determine whether continuous communication of an antenna 120 with a satellite constellation is available. Antenna 120 can be communicatively coupled (e.g., via a coaxial cable) to user terminal 125 that can be positioned at a stationary location (e.g., within a home). In some cases, antenna 120 can be an electronically steered phased array antenna that can use beam steering to adjust a radiation pattern of antenna 120. Mobile device 110 can include: processing system 130; storage system 140; sensor system 150; camera 160; and display 170. In some implementations, components of some or all of mobile device can be implemented in a computational system or environment. Processing system 130 of mobile device 110 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using storage system 140, which can comprise one or more non-transitory processor-readable mediums, such as random-access memory (RAM), flash memory, a hard disk drive (HDD), or a solid state drive (SSD). In some examples, mobile device 110 additionally can include a communications system, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like.

Sensor system 150 can include one or more sensors to detect changes in an orientation or a position of mobile device 110. For example, sensor system 150 can include an inertial measurement unit (IMU) such as an accelerometer to detect changes in linear acceleration with respect to mobile device 110. As another example, sensor system 150 can include a gyroscope to monitor rotational forces with respect to mobile device 110. The sensors of sensor system 150 can communicate with each other to determine changes to the orientation or the position of mobile device 110, for example to detect if mobile device 110 has been rotated from a portrait orientation to a landscape orientation.

Mobile device 110 can output prompts or visual cues via augmented reality (AR) application 142 of user interface 172 to guide an operator during a scanning process to capture visual data of an overhead area associated with installing antenna 120. In some cases, AR application 142 can be stored in storage system 140. Additionally, processing system 130 can include a graphics processing unit (GPU) to facilitate image processing with respect to AR application 142. Examples of the visual data can include images, video, or a combination thereof. As an example, camera 160 can be used to provide a field of view of an overhead area associated with antenna 120 via user interface 172 outputted using display 170. Mobile device 110 can capture the visual data (e.g., one or more frames captured sequentially) of the field of view via camera 160 as the operator moves mobile device 110. For example, the operator can rotate while holding mobile device 110 to capture a set of frames that collectively represent a 360-degree view of the overhead area. As mobile device 110 is rotated, sensor system 150 can collect azimuthal data or elevation data corresponding to each frame captured by camera 160. AR application 142 can be used to overlay the prompts or visual cues on user interface 172 to indicate progress of the scanning process. In some cases, the visual cues can include one or more graphical elements that disappear once a suitable frame associated with the graphical elements is captured.

Additionally or alternatively, the prompts or visual cues can be used to indicate a minimum elevation (e.g., 37° from horizontal) at which mobile device 110 needs to be tilted prior to camera 160 capturing the visual data. User interface 172 can indicate when the minimum elevation is reached based on the elevation data obtained by sensor system 150. Tilting mobile device 110 to meet the minimum elevation can ensure that suitable visual data is collected during the scanning process. For example, the minimum elevation can prevent the operator from scanning areas (e.g., ground) that lack open sky. In some cases, AR application 142 may avoid displaying an interface element used to initiate the scanning process until the operator tilts mobile device 110 to meet the minimum elevation.

Once one or more frames of the field of view are captured using camera 160, the mobile device 110 can execute machine-learning model 144 to analyze the frames to determine whether continuous communication with the satellite constellation is sufficiently available. In some cases, machine-learning model 144 can be a computer vision model that can be trained to detect objects in images. The field of view surveyed by mobile device 110 can include one or more obstructions that can obstruct a clear view of the sky in the overhead area. Accordingly, machine-learning model 144 may analyze the frames to determine if any regions of the overhead area associated with antenna 120 have an obstruction to a direct line of sight to the sky. Based on the output of machine-learning model 144, AR application 142 can output obstruction map 174 via display 170 to indicate obstructed portions of the overhead area. In some cases, if machine-learning model 144 identifies a relatively high percent of obstructions (e.g., above a predefined threshold), obstruction map 174 can indicate that antenna 120 of user terminal 125 needs to be physically located or installed elsewhere to avoid the obstructions. Although machine-learning model 114 is used to analyze the frames to determine obstructions in the overhead area, it will be appreciated that other forms of analysis are possible in addition to or instead of using machine learning.

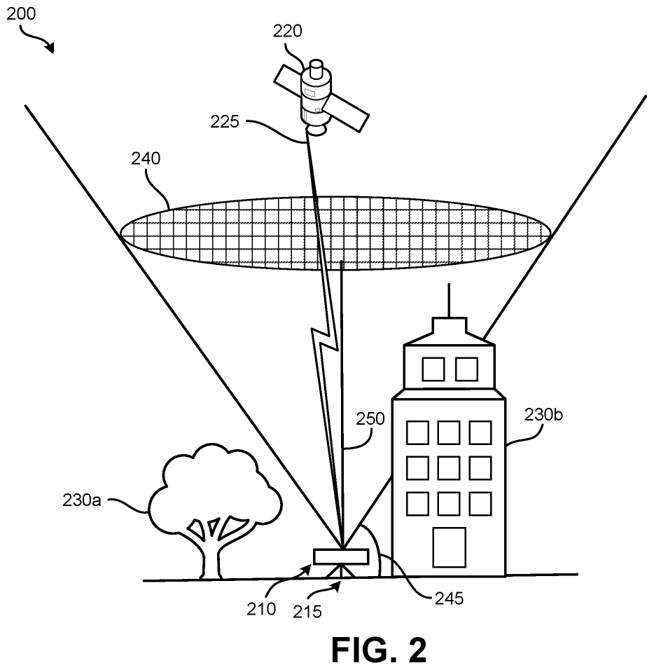

FIG. 2 illustrates an embodiment of a satellite communication system 200 including an antenna 210 communicatively coupled with a satellite 220. Antenna 210 can be communicatively coupled to a user terminal, as detailed in relation to FIG. 1. In some implementations, antenna 210 can include a mounting stand 215 to support and elevate antenna 210. While the illustrated embodiment depicts one satellite 220, it should be understood that satellite 220 can be part of a satellite constellation having more than one satellite. For example, some architectures include multiple satellites, such as cooperating satellites in a constellation, multiple satellites with overlapping coverage areas, etc. Satellite 220 can relay wireless signals 225 to antenna 210 that can function as a transceiver antenna. Such communication can be referred to as downlink communications. In some cases, both downlink communication and uplink communications can be performed. Uplink communications can include transmissions from antenna 210 to satellite 220. Satellite 220 can be in low earth orbit (LEO) or medium earth orbit (MEO); therefore, as satellite 220 orbits the earth, the direction from antenna 210 of the user terminal to satellite 220 changes.

In some cases, satellite communication system 200 may be used to provide access to public and/or private networks (e.g., Internet access). The user terminal can be part of user equipment that may be located at a fixed geographic location. The fixed geographic location may be a residence, a building, an office, a worksite, or any other fixed location at which Internet access is desired. For example, antenna 210 for the user terminal may be installed at a residence of a subscriber that has a service contract with a provider associated with satellite communication system 200. In some cases, antenna 210 for the user terminal can be associated with an individual subscriber to satellite communication services provided via satellite communication system 200, with a corporate or other entity user, with a robotic user, with an employee of the provider, etc. While FIG. 2 illustrates only one instance of antenna 210, satellite communication system 200 may involve any suitable number (e.g., hundreds or thousands) of instances of antennas distributed across various geographic locations. Some number of these instances may be in relatively fixed locations, while others of these instances may have periodically or constantly changing locations (e.g., antennas for mobile terminals, antennas for aero terminals for providing Internet service in aircraft, or the like).

The fixed geographic location may include one or more obstructions 230a-b (e.g., a line-of-sight obstruction) associated with antenna 210. Obstructions 230a-b can be physical obstructions that can block or interfere with antenna 210 receiving wireless signals 225 from satellite 220. For example, obstructions 230a-b may decrease open sky available for communication with satellite 220 by impeding a line of sight from antenna 210 to satellite 220. Examples of obstructions 230a-b can include a cell tower, a tree 230a, a building 230b, a mountain, etc. In some cases, interference caused by obstructions 230a-b may lower the open sky associated with antenna 210 below a predefined threshold such that satellite communication system 200 is unable to provide access to the public and/or private networks.

In some examples, the predefined threshold can be independent of an orientation of antenna 210. As an example, if antenna 210 has a north-south orientation, the predefined threshold may be the same for a subset of overhead area 240 positioned north or south of antenna 210 compared to another subset of overhead area 240 positioned east or west of antenna 210. Additionally or alternatively, the predefined threshold can vary based on a quality of service associated with the user terminal. For example, a higher Internet speed may require or be associated with a higher predefined threshold compared to a lower Internet speed that may have a lower requirement with respect to an amount of the open sky that is available.

To avoid relocating antenna 210 after installation due to the interference from obstructions 230a-b, an operator can use mobile device 110 to capture visual data of overhead area 240 that can be analyzed using a machine-learning model 144, as detailed above in relation to FIG. 1. In some cases, the operator can be an end user associated with the user terminal. AR application 142 can be installed on mobile device 110 to guide the operator through a scanning process to obtain the visual data. In some examples, mobile device 110 may need to be tilted at elevation angle 245 within a predefined range (e.g., from 37° to 90° from horizontal) to ensure that camera 160 can capture at least part of overhead area 240.

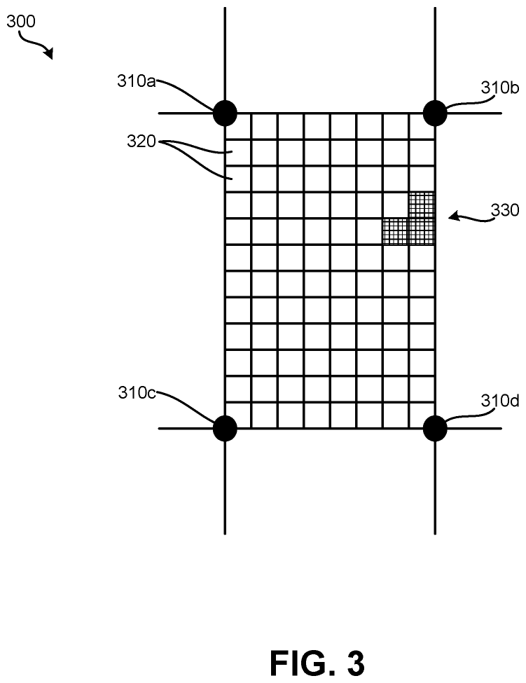

AR application 142 can use height 250 and elevation angle 245 to calculate an area corresponding to overhead area 240. Height 250 can be estimated based on a distance between antenna 210 and satellite 220. Using trigonometry, a radius r of the area corresponding to overhead area 240 can be determined using Equation 1 below:

$$r = \frac{h}{tan θ} \qquad ( Eq . 1 )$$

where h represents height 250 and θ represents elevation angle 245. As depicted in FIG. 2, the machine-learning model can divide overhead area 240 into one or more block regions that can be analyzed using image segmentation to identify regions containing open sky or obstructions. Further details of analyzing overhead area 240 are described below with respect to FIG. 3.

FIG. 3 illustrates an embodiment of a block region 300 of a frame captured by a mobile device (e.g., mobile device 110 of FIG. 1). For example, referring to FIGS. 1-2, block region 300 can be a subset of overhead area 240 that can be represented using one or more frames captured by camera 160 of mobile device 110. Determining block region 300 can involve identifying four points that can each correspond to a respective corner of block region 300. A mobile application installed on a mobile device (e.g., AR application 142 installed on mobile device 110 of FIG. 1) can determine a horizontal field of view angle and a vertical field of view angle based on a focal length of a camera of the mobile device. Additionally, the mobile application can determine dimensions (e.g., width, height, etc.) of a display of the mobile device. In some examples, the mobile application can store the dimensions associated with the mobile device within memory (e.g., storage system 140 of FIG. 1).

For each frame captured by the camera, the mobile application can identify a center point including an initial azimuthal angle and an initial elevation angle. The center point can correspond to a central location of the mobile device. Based on the center point, the mobile application can determine one or more relative angles associated with a respective block region within each frame. For example, the relative angles can include four angles: a minimum azimuthal angle, a maximum azimuthal angle, a minimum elevation angle, and a maximum elevation angle. In some cases, the azimuthal angles can range from 0° to 360°, while the elevation angles can range from 37° to 90°. The four angles can be used to define corners 310a-d of block region 300. As an illustrative example, the minimum azimuthal angle for block region 300 can be 30°, and the minimum elevation angle for block region 300 can be 45°. Additionally, maximum azimuthal angle for block region 300 may be 35°, while the maximum elevation angle for block region 300 may be 50°. Thus, a first corner 310a of block region 300 can correspond to a point of (30, 50) if mapped on a two-dimensional grid (e.g., a coordinate plane). Similarly, a second corner 310b, a third corner 310c, and a fourth corner 310d of block region 300 can correspond to a coordinate of (35, 50), (30, 45), and (35, 45), respectively. In other words, on a two-dimensional grid, the azimuthal angles can correspond to an abscissa of a coordinate for a respective corner of block region 300, and the elevation angles can correspond to an ordinate of the coordinate.

In some implementations, block region 300 can include one or more pixels 320 of a particular frame captured by the mobile device. The mobile application can use a machine-learning model (e.g., machine-learning model 144 of FIG. 1) to perform image segmentation to analyze block region 300. Image segmentation can involve partitioning an image into a set of image segments that each can include one or more pixels. Semantic segmentation is an approach of image segmentation that can involve detecting a belonging class of each pixel or image segment and assigning a class identifier associated with a respective belonging class to each pixel or image segment. In the case of block region 300, the machine-learning model can apply semantic segmentation to classify different regions of block region 300 and determine whether block region 300 includes any obstructions. For example, the machine-learning model can be trained to identify non-obstructive objects (e.g., clouds, birds, planes, etc.) and obstructive objects (e.g., trees, architecture, mountains, etc.) captured in visual data of the overhead area. In some cases, once trained, the machine-learning model can automatically classify the different regions of block region 300 to minimize human intervention with respect to image segmentation. The machine-learning model can be trained prior to the mobile application being installed on the mobile device.

Training the machine-learning model can involve iteratively supplying training data to the machine-learning model, enabling the machine-learning model to identify patterns related to the training data or to identify relationships between the training data and output data. For example, the patterns or the relationships associated with the training data may involve whether an object is an obstruction. In some implementations, at least part of the training data used to train the machine-learning model can be computer-generated. For example, a different machine-learning model can use deep learning methodologies to generate images based on natural language input that can be supplied as training data to the machine-learning model. Additionally, the machine-learning model can be retrained over time to improve its accuracy and abilities, for example with respect to identifying obstructive objects. For instance, the machine-learning model can be further trained using an updated training dataset containing visual data (e.g., the frames of overhead area 240 of FIG. 2) captured by the camera or by other devices that have installed the mobile application. Training datasets for the machine-learning model may be updated over time to enable improvements to the machine-learning model.

In some cases, the machine-learning model can determine that at least one pixel 330 of pixels 320 includes an obstruction (e.g., part of obstructions 230a-b of FIG. 2). For example, image segmentation performed by the machine-learning model may identify a branch of a tree in pixel(s) 330, indicating that pixel(s) 330 contains or is associated with an obstruction. Once at least one pixel 330 of pixels 320 is considered obstructed after being analyzed by the machine-learning model, block region 300 can be assigned or tagged with an obstruction identifier (e.g., metadata). The obstruction identifier can indicate that a subset of the overhead area corresponding to block region 300 is obstructed. Based on an amount of block regions in the overhead area that are assigned the obstruction identifier, the machine-learning model can determine or estimate a percentage or another suitable quantification for open sky available for an antenna of the user terminal to communicate with a satellite constellation.

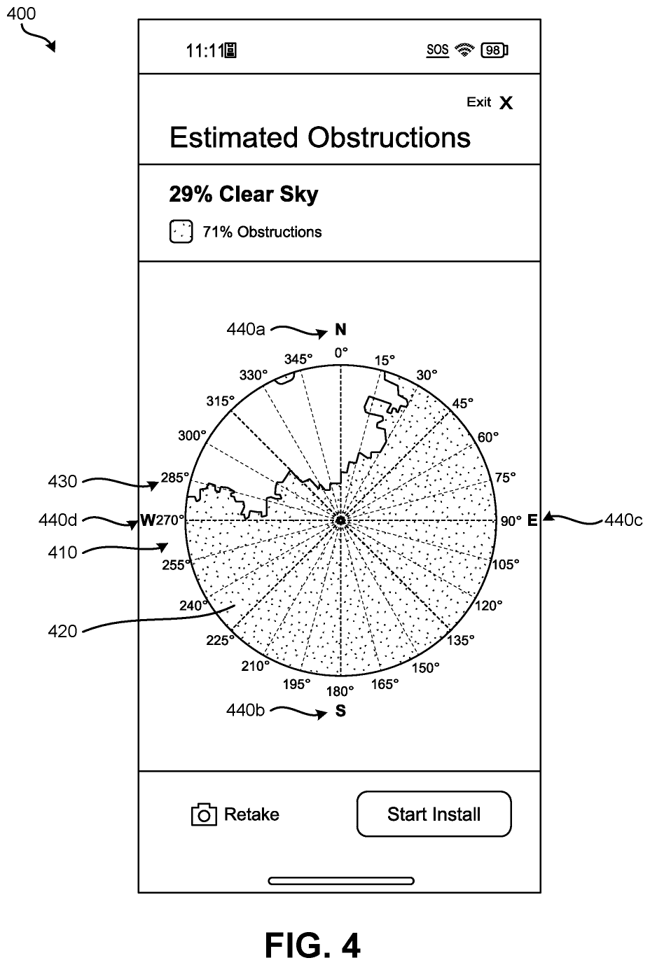

FIG. 4 illustrates an embodiment of an obstruction map 400 outputted via a user interface of a mobile device (e.g., user interface 172 of mobile device 110). In some examples, obstruction map 400 can indicate an amount (e.g., percentage) of open sky available for continuous communication between an antenna and a satellite constellation (e.g., antenna 210 and satellite 220 of FIG. 2). Additionally or alternatively, referring to FIG. 2, obstruction map 400 may indicate an amount of obstructions 230a-b detected in overhead area 240. For example, as depicted in FIG. 4, obstruction map 400 indicates that 29% of open sky is available, while 71% of the overhead area is obstructed.

If the amount of the open sky is above a predefined threshold, obstruction map 400 may include a recommendation to proceed with installing the antenna of a user terminal at a location associated with the overhead area. Alternatively, in some examples, if the amount of the open sky is below the predefined threshold, obstruction map 400 can output a different recommendation to select a different location to install the antenna. As another example, if the amount of the open sky is below the predefined threshold but within a close range (e.g., 1% or 2%) of the predefined threshold, obstruction map 400 may provide another recommendation to retake visual data at the location associated with the overhead area. In some cases, if the mobile device is used to retake or capture additional visual data, the mobile device may store the visual data, recommendation, or obstruction map of a previous scan to compare with the additional visual data or results generated using the additional visual data.

Besides providing a quantification associated with the open sky available with respect to the overhead area, obstruction map 400 can include a two-dimensional representation 410 of the overhead area. Referring to FIG. 2, at least one visual indicator 420 can be overlaid on two-dimensional representation 410 to indicate a respective location of obstructions 230a-b detected in overhead area 240. Visual indicator 420 can involve adjustments to transparency, hue, saturation, brightness, contrast, pattern, or other suitable visual adjustments to the underlying two-dimensional representation 410. In some examples, visual indicator 420 can correspond to block regions (e.g., block region 300) of the overhead area that have been assigned an obstruction identifier, as detailed in relation to FIG. 3.

In addition to two-dimensional representation 410, obstruction map 400 may include at least one azimuthal identifier 430 adjacent to or overlaid on two-dimensional representation 410. For example, as depicted in FIG. 4, azimuthal identifier 430 can be part of a set of azimuthal identifiers encompassing 0° to 360° in intervals of 15°. Additionally or alternatively, obstruction map 400 can include one or more cardinal direction indicators 440a-d to assist with direction determination. For example, as depicted in FIG. 4, first cardinal direction indicator 440a corresponds to north. Similarly, second cardinal direction indicator 440b, third cardinal direction indicator 440c, and fourth cardinal direction indicator 440d correspond to south, east, and west, respectively. Although only four cardinal direction indicators 440a-d are provided in FIG. 4, it will be appreciated that less than or more than four cardinal direction indicators are possible. In some implementations, obstruction map 400 may include intercardinal directions (e.g., northeast, southeast, etc.), secondary intercardinal directions (e.g., west-northwest, north-northwest, etc.), or a combination thereof.

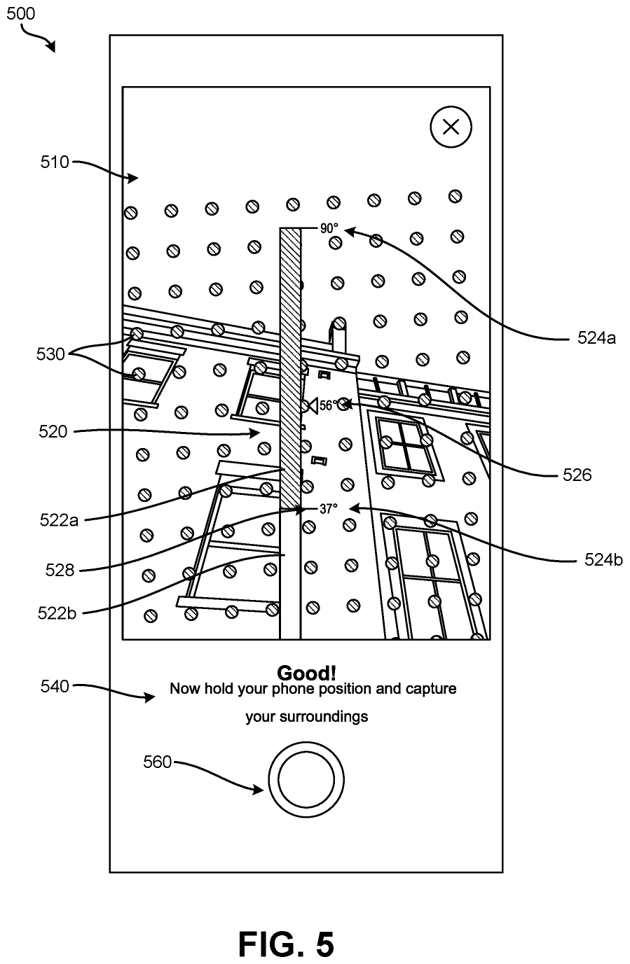

In FIGS. 5-8, various user interfaces outputted when collecting visual data of an overhead area associated with an antenna for a user terminal (e.g., overhead area 240 and antenna 210 of FIG. 2) are presented. FIG. 5 illustrates an embodiment of a user interface 500 to guide an operator when obtaining visual data of the overhead area associated with installing the antenna for the user terminal. When guiding the operator to scan the overhead area, user interface 500 can include field of view 510; elevation indicator 520; and graphical elements 530. In some examples, user interface 500 additionally may include text box 540.

Through a display of a mobile device used by the operator, user interface 500 can display or output field of view 510 captured by a camera of the mobile device as detailed in relation to FIG. 1. User interface 500 can include elevation indicator 520 to provide a visual indication of an elevation angle (e.g., elevation angle 245 of FIG. 2) at which the mobile device is positioned (e.g., tilted). Although elevation indicator 520 is depicted as a vertical bar in FIGS. 5-7, other shapes or representations of elevation indicator 520 are possible. For example, instead of providing the vertical bar as elevation indicator 520, user interface 500 may include a numerical representation of the elevation angle. The elevation angle can be an angle formed between a horizontal line and a line of sight associated with the mobile device and can be determined using data collected by a sensor system of the mobile device. As depicted in FIG. 5, elevation indicator 520 can include a first color indicator 522a and a second color indicator 522b. Additionally, one or more angle labels 524 can be positioned along elevation indicator 520 as a reference for the elevation angle of the mobile device. In some implementations, as depicted in FIG. 5, an angle indicator 526 can move along elevation indicator 520 to indicate a current elevation angle and changes in the elevation angle of the mobile device. Angle indicator 526 may include an arrow and an angle label corresponding to the elevation angle.

A specific angle label of the angle label(s) 524 can correspond to predefined angle 528 (e.g., 37° from horizontal) at which to tilt the mobile device such that the visual data of at least part of the overhead area associated with the antenna can be captured. In some cases, predefined angle 528 may differ depending on dimensions or specification of the mobile device or components (e.g., camera, etc.) of the mobile device. A point along elevation indicator 520 at which first color indicator 522a is contiguous to second color indicator 522b can indicate predefined angle 528 associated with the mobile device. Additionally, first color indicator 522a can indicate a range of elevation angles within which the elevation angle of the mobile device is at or above predefined angle 528. In some cases, if the mobile device is oriented at an elevation angle below predefined angle 528, field of view 510 of the camera may exclude or omit the overhead area. Accordingly, user interface 500 may avoid providing interface element 560 that can be selected to initiate capturing of the visual data of the overhead area until the elevation angle of the mobile device meets or exceeds predefined angle 528. User interface 500 can provide text box 540 containing textual instructions or information, for example indicating that the elevation angle of the mobile device needs to be tilted further to reach predefined angle 528. As another example, as depicted in FIG. 5, instructions provided in text box 540 may indicate that the elevation angle is at or above predefined angle 528 such that the operator can proceed with capturing the visual data using the camera of the mobile device.

An AR application can overlay one or more graphical elements 530 on field of view 510 (e.g., in a specific pattern) to guide the operator and to indicate progress of the scanning process. Although graphical elements 530 are depicted as circular dots in FIGS. 5-7, it will be appreciated that other shapes (e.g., squares, triangles, etc.) for graphical elements 530 are possible. User interface 500 displays graphical elements 530 arranged in an array, grid, matrix, or other suitable geometric patterns, such as patterns derived from a Fibonacci series. In some cases, an arrangement of graphical elements 530 displayed by user interface 500 can include rows and columns of graphical elements 530. Graphical elements 530 being presented on user interface 500 can prompt the operator to adjust a positioning or an orientation of the mobile device when capturing the visual data. As portions of the environment (e.g., the overhead area) are captured via the scanning process, individual graphical elements may be eliminated to indicate portions of the environment that have been successfully captured. When all (or at least most) graphical elements 530 are removed from field of view 510, the environment has been sufficiently imaged.

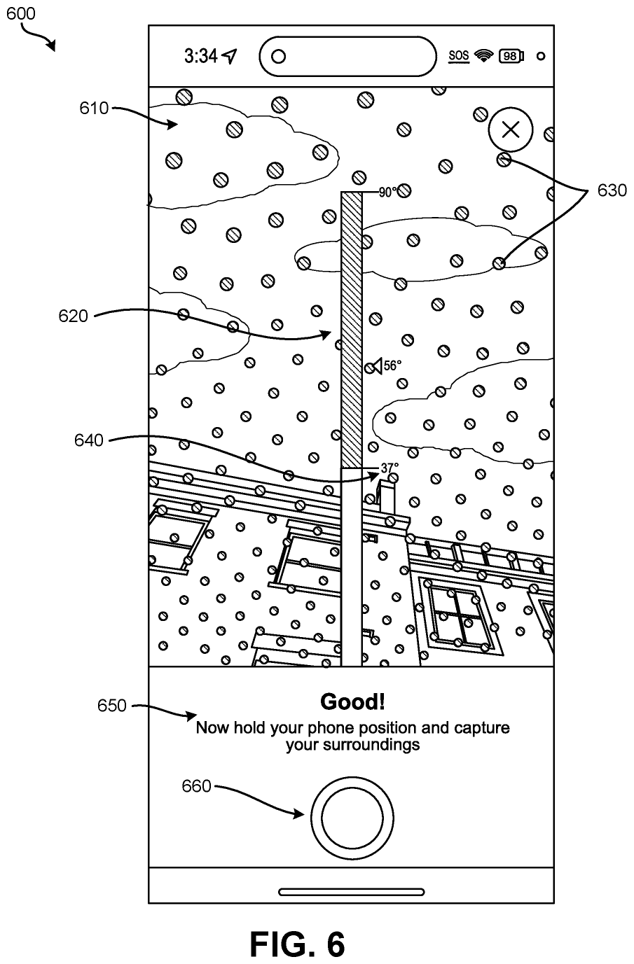

FIG. 6 illustrates another embodiment of a user interface 600 to guide an operator when obtaining visual data of an overhead area associated with installing an antenna for a user terminal (e.g., overhead area 240 and antenna 210 of FIG. 2). User interface 600 can include field of view 610; elevation indicator 620; graphical elements 630; predefined angle 640; text box 650; and interface element 660. Certain components of FIG. 6 are detailed in relation to FIG. 5. In some implementations, as depicted in FIG. 6, user interface 600 can include graphical elements 630 overlaid on field of view 610 based on a sunflower algorithm.

As depicted in FIG. 6, instead of being arranged in linear rows and columns, graphical elements 630 are organized as radial lines with a clockwise spiral or a counterclockwise spiral. A pattern used to arrange graphical elements 530 of FIG. 5 and graphical elements 630 of FIG. 6 can differ based on an operating system of a mobile device on which an AR application used to provide the graphical elements is installed. To determine a number of graphical elements 630 to overlay on user interface 600, the AR application can use a constant height and an elevation angle to calculate an area corresponding to the overhead area, as detailed in relation to FIG. 2. In some cases, the elevation angle used can be predefined angle 640. The number of graphical elements 630 can correspond to r². A position x (e.g., relative to a central location of the mobile device) of a particular graphical element of graphical elements 630 can be defined according to Equation 2 below:

$$x = \frac{2 π}{{φ}^{2} n} \qquad ( Eq . 2 )$$

where

$$φ = \frac{1 + \sqrt{5}}{2}$$

and n represents the number of graphical elements 630. Additionally, a radius of the particular graphical element from the central location can correspond to n^{0.5}, wherein n represents the number of graphical elements 630.

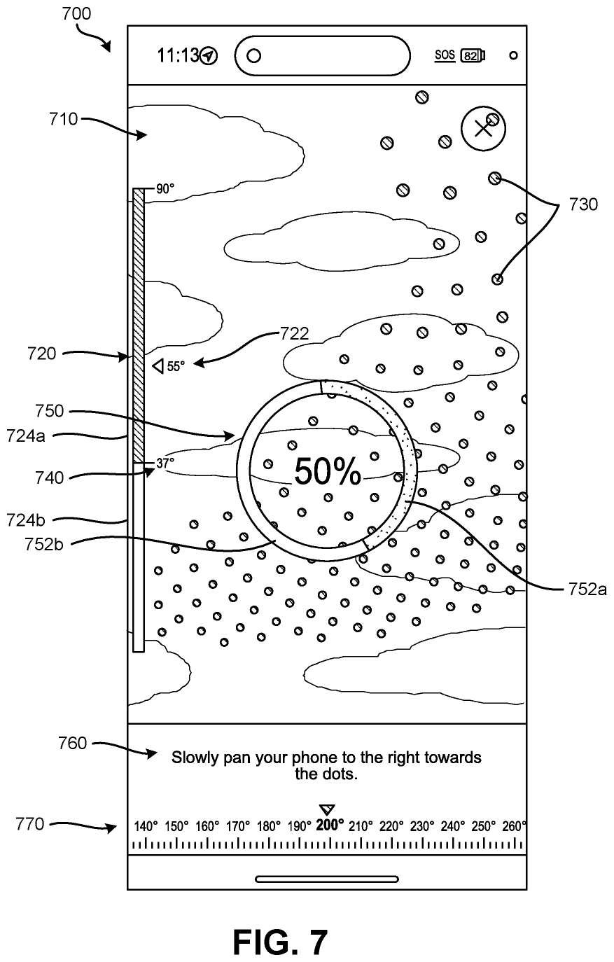

FIG. 7 illustrates an embodiment of a user interface 700 when obtaining visual data of an overhead area associated with installing an antenna for a user terminal (e.g., overhead area 240 and antenna 210 of FIG. 1) is in progress. User interface 700 can include field of view 710; elevation indicator 720; remaining graphical elements 730; predefined angle 740; progress indicator 750; text box 760; and azimuthal indicator 770. Certain components of user interface 700 are detailed in relation to FIGS. 5-6. For example, elevation indicator 720 of user interface 700 indicates a current elevation angle using angle indicator 722 and predefined angle 740 using first color indicator 724a and second color indicator 724b.

Compared to user interface 600 of FIG. 6, fewer graphical elements are provided on user interface 700. In some examples, referring to FIG. 6, once a specific frame of field of view 610 is captured, a subset of the graphical elements 630 can be removed from user interface 600 to indicate that the specific frame has been successfully captured. Based on the subset of the graphical elements removed from the user interface, the progress of capturing the visual data can be determined. In other words, referring to FIG. 6, the progress can be relative to the subset of the graphical elements removed from user interface 600 compared to an initial amount of graphical elements 630 generated by an AR application on user interface 600. As another example, the progress may be relative to an amount of remaining graphical elements 730 compared to the initial amount of graphical elements (e.g., graphical elements 630 of FIG. 6).

In some examples, progress indicator 750 can be outputted on user interface 700 to track the progress of capturing the visual data associated with the overhead area. Progress indicator 750 provided via user interface 700 can include a percentage or another suitable quantification of the progress associated with capturing sufficient visual data for a 360-degree representation of the overhead area. For example, as depicted in FIG. 7, progress indicator 750 provides a numerical indication that 50% of the 360-degree representation has been captured.

In some implementations, progress indicator 750 can use third color indicator 752a to track the progress of capturing the visual data by visualizing an amount of remaining graphical elements 730. In comparison, fourth color indicator 752b of progress indicator 750 can represent an initial amount of graphical elements provided via the AR application. In some examples, third color indicator 752a and fourth color indicator 752b can be the same colors as first color indicator 724a and second color indicator 724b, respectively. A ratio or comparison of fourth color indicator 752b to third color indicator 752a can correspond to the numerical indication of progress indicator 750. User interface 700 can include remaining graphical elements 730 to indicate which areas or azimuths lack sufficient captured visual data.

FIG. 7 can include azimuthal indicator 770 provided by user interface 700. Azimuthal indicator 770 can indicate a current azimuth of the mobile device in a set of azimuth labels. For example, azimuthal indicator 770 of user interface 700 indicates that the mobile device is positioned at an azimuth of 200°. Additionally, text box 760 can provide written instructions to guide the operator using the mobile device to capture visual data corresponding to remaining graphical elements 730. For example, the written instructions can prompt the operator to rotate clockwise while holding the mobile device to obtain visual data corresponding to remaining graphical elements 730 positioned at a right side of user interface 700.

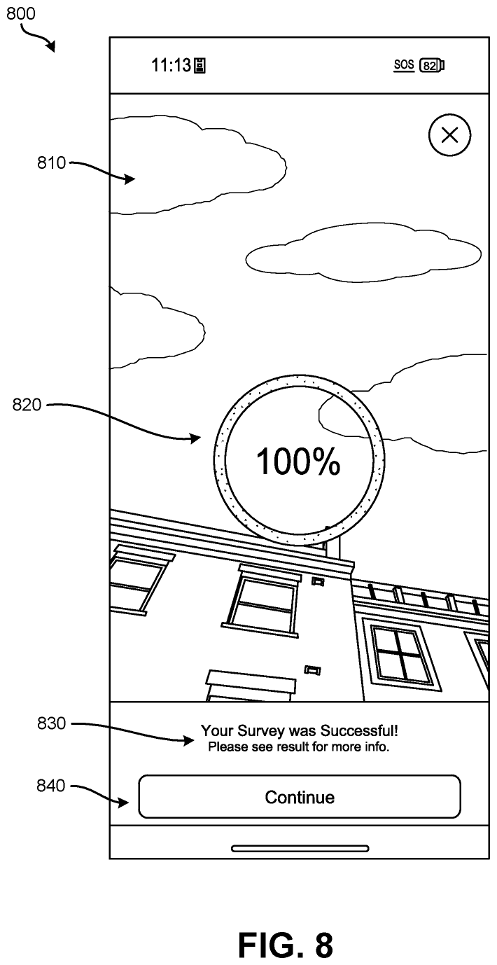

FIG. 8 illustrates an embodiment of a user interface 800 when obtaining visual data of an overhead area associated with installing an antenna for a user terminal (e.g., overhead area 240 and antenna 210 of FIG. 2) is completed. User interface 800 can include field of view 810; progress indicator 820; text box 830; and interface element 840. Certain aspects of FIG. 8 are detailed below in relation to components of FIGS. 5-7.

The process of capturing visual data of the overhead area described above in relation to FIG. 7 can be repeated until a 360-degree representation of the overhead area is complete. Once progress of capturing the visual data is complete (e.g., reaches 100%), all remaining graphical elements 730 of FIG. 7 may be removed or disappear. This can indicate that the mobile application has successfully obtained frames or other suitable visual data of the overhead area to map the 360-degree representation. As depicted in FIG. 8, only progress indicator 820 remains on field of view 810 provided by user interface 800. Text box 830 can provide an indication that surveying the overhead area was successfully completed. In some examples, interface element 840 can be provided by user interface 800 to enable the operator to advance to a different user interface (e.g., a user interface providing obstruction map 400 of FIG. 4).

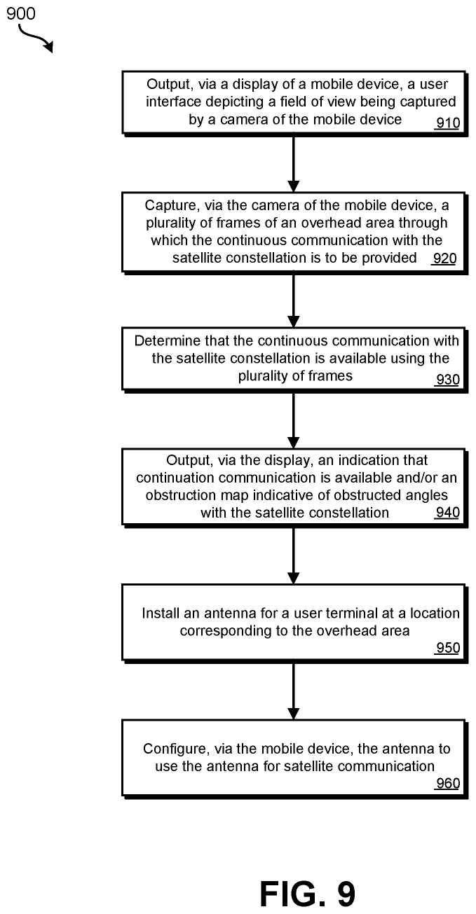

Various methods may be performed using the arrangements detailed in FIGS. 1-8. FIG. 9 illustrates an embodiment of a method 900 for generating an obstruction map based on an availability of continuous communication with a satellite constellation. Method 900 may be performed by a system or device that is to receive data, such as mobile device 110.

At block 910, a mobile application (e.g., AR application 142 of FIG. 1) can output, via a display of a mobile device, a user interface depicting a field of view being captured by a camera of the mobile device on which the mobile application is installed. For example, referring to FIG. 1, AR application 142 can communicate with camera 160 to display the field of view from camera 160 via user interface 172. The field of view provided by camera 160 can depend on specifications (e.g., resolution, pixel size, focal length, etc.) of camera 160. When an operator moves (e.g., rotates) mobile device 110 to a different position, display 170 of mobile device 110 can update or refresh concurrently to display an updated field of view based on the different position.

At block 920, the camera can capture one or more frames of an overhead area through which the continuous communication with the satellite constellation is provided. The frames can collectively map a 360-degree representation of the overhead area. In some examples, the camera may record video of the overhead area in addition to or instead of the frames. As detailed in relation to FIGS. 1-2, mobile device 110 can be positioned at elevation angle 245 that is within a predefined range of suitable elevation angles such that camera 160 of mobile device 110 can capture the frames of overhead area 240. The predefined range can have a predefined angle as a minimum angle at which the mobile device needs to be tilted to capture at least part of the overhead area. Referring to FIG. 5, to ensure that the mobile device is suitably positioned, user interface 500 of the mobile device can include an elevation indicator 520 that can indicate when the mobile device is tilted at predefined angle 528.

At block 930, the mobile application can determine that the continuous communication with the satellite constellation is available using the frames. In some examples, the mobile application can execute a machine-learning model trained to perform image segmentation to analyze the frames of the overhead area and determine open sky available for continuous communication with the satellite constellation. For example, the machine-learning model can implement semantic segmentation to associate a label or a category (e.g., obstructed, unobstructed, etc.) with each pixel of a respective frame captured by the camera. The label or the category of each pixel can indicate whether the pixel contains or is associated with an obstruction. Additionally, in some cases, each frame can be divided into a set of block regions with each block regions of the set of block regions containing one or more pixels. In such cases, if at least one pixel in a block region is categorized as containing an obstruction, the entire block region can be tagged with an obstruction identifier such that the entire block region is considered obstructed.

After analyzing the frames, the machine-learning model can quantify the open sky available for continuous communication with the satellite constellation. For example, the machine-learning model may output a percentage of open sky available or a percentage of the overhead area that is obstructed. If an amount of the open sky is above a predefined threshold, the machine-learning model can indicate that the continuous communication with the satellite constellation is available. Alternatively, in some examples, the machine-learning model may determine that the continuous communication with the satellite constellation is unavailable, for example based on the amount of the open sky being below the predefined threshold. In such examples, the mobile application may output a recommendation via the display to suggest that the operator consider a different location for installing the antenna of the user terminal.

At block 940, the display outputs an obstruction map based on the frames that indicates the open sky available for communication with the satellite constellation. Referring to FIG. 4, obstruction map 400 can include a two-dimensional representation 410 of the overhead area to indicate regions of the overhead area that are obstructed or associated with open sky. For example, as depicted in FIG. 4, two-dimensional representation 410 can be overlaid with a visual indicator 420 to differentiate or designate obstructed regions of the overhead area. Using the obstruction map to visualize obstructed regions of the overhead area can enable quicker, more informed decision-making about whether to install the antenna for the user terminal at the location associated with the overhead area.

At block 950, the antenna for the user terminal is installed at the location corresponding to the overhead area that is analyzed using the mobile application. The antenna can be installed after the obstruction map indicates that the location enables suitable communication with the satellite constellation based on the amount of the open sky available at the location. In some cases, the mobile application may output (e.g., via the display) instructions that an operator can follow to install the antenna. For example, the instructions may include attaching or securing an antenna mount to a suitable surface at the location prior to mounting the antenna on the antenna mount. As another example, the instructions can include communicatively coupling the antenna to the user terminal using a coaxial cable.

At block 960, the mobile device can configure the antenna to use the antenna for satellite communication (e.g., accessing public and/or private networks). The mobile application of the mobile device can be used to set up or configure the antenna after installation, for example to initiate a data session to establish communication with the satellite constellation. Once the communication with the satellite constellation is established, the mobile application can initiate one or more tests to assess or evaluate a connection of the antenna to the satellite constellation. For example, the mobile application can be used to run a ping test to confirm whether there is connectivity between the antenna and the satellite constellation. Additionally, the ping test can determine latency associated with the communication between the antenna and the satellite constellation. As another example, a speed test can be initiated by the mobile application to assess data throughput associated with the connection between the antenna and the satellite constellation.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system to determine availability of continuous communication with a satellite constellation, the system comprising:
a mobile device, comprising a non-transitory processor readable medium, a display, one or more processors, and a camera, the mobile device having installed an augmented reality (AR) application configured to:
output, via the display of the mobile device, a user interface depicting a field of view being captured by the camera;
capture, via the camera of the mobile device, a plurality of frames of an overhead area through which the continuous communication with the satellite constellation is to be provided, the plurality of frames collectively mapping a 360-degree representation of the overhead area;
determine that the continuous communication with the satellite constellation is available using the plurality of frames; and
output, via the display, an obstruction map based on the plurality of frames that indicates open sky available for communication with the satellite constellation.

2. The system of claim 1, wherein the AR application is further configured to:
determine a recommendation with respect to installing an antenna for a user terminal based on a predefined threshold with respect to the open sky available for communication with the satellite constellation; and
output, via the user interface, the obstruction map, wherein the obstruction map comprises a visual indicator associated with the open sky available for communication with the satellite constellation and the recommendation.

3. The system of claim 2, wherein the predefined threshold with respect to the open sky available for communication with the satellite constellation is independent of an orientation of the antenna.

4. The system of claim 1, wherein the AR application configured to determine that the continuous communication with the satellite constellation is available is further configured to execute a machine-learning model to:
identify a block region of the plurality of frames, wherein the block region comprises a plurality of pixels;
determine that at least one pixel of the plurality of pixels includes an obstruction by performing image segmentation; and
assign an obstruction identifier to the block region associated with the at least one pixel, wherein the obstruction identifier indicates that the overhead area corresponding to the block region is obstructed.

5. The system of claim 1, wherein the AR application is further configured to, prior to capturing the plurality of frames of the overhead area:
output an elevation indicator overlaying the user interface, wherein the elevation indicator is configured to indicate a predefined angle at which to tilt the mobile device prior to capturing the plurality of frames of the overhead area; and
subsequent to the mobile device being tilted at the predefined angle, provide, via the user interface, an interface element configured to be selected to initiate the capturing step.

6. The system of claim 1, wherein the AR application configured to capture the plurality of frames is further configured to:
output, via the user interface, one or more graphical elements overlaying the field of view, wherein an amount of the one or more graphical elements is configured to indicate progress of the capturing step;
capture a particular frame of the plurality of frames, wherein the particular frame corresponds to a subset of the one or more graphical elements;
in response to the capture of the particular frame, remove a subset of the one or more graphical elements from the user interface; and
output a progress indicator corresponding to the subset of the one or more graphical elements removed from the user interface.

7. The system of claim 1, wherein the obstruction map further comprises a two-dimensional representation of the overhead area, azimuthal identifiers with respect to the two-dimensional representation, and cardinal direction indicators with respect to the two-dimensional representation, and wherein the two-dimensional representation includes a visual indicator configured to indicate a respective location of obstructions detected in the overhead area.

8. A method to determine availability of continuous communication with a satellite constellation, the method comprising using an augmented reality (AR) application installed on a mobile device to perform operations comprising:
outputting, via a display of the mobile device, a user interface depicting a field of view being captured by a camera of the mobile device;
capturing, via the camera of the mobile device, a plurality of frames of an overhead area through which the continuous communication with the satellite constellation is to be provided, the plurality of frames collectively mapping a 360-degree representation of the overhead area;
determining that the continuous communication with the satellite constellation is available using the plurality of frames; and
outputting, via the display, an obstruction map based on the plurality of frames that indicates open sky available for communication with the satellite constellation.

9. The method of claim 8, further comprising:
determining a recommendation with respect to installing an antenna for a user terminal based on a predefined threshold with respect to the open sky available for communication with the satellite constellation; and
outputting, via the user interface, the obstruction map, wherein the obstruction map comprises a visual indicator associated with the open sky available for communication with the satellite constellation and the recommendation.

10. The method of claim 9, wherein the predefined threshold with respect to the open sky available for communication with the satellite constellation is independent of an orientation of the antenna.

11. The method of claim 8, wherein the determining that the continuous communication with the satellite constellation is available further comprises executing a machine-learning model for:
identifying a block region of the plurality of frames, wherein the block region comprises a plurality of pixels;
determining that at least one pixel of the plurality of pixels includes an obstruction by performing image segmentation; and
assigning an obstruction identifier to the block region associated with the at least one pixel, wherein the obstruction identifier indicates that the overhead area corresponding to the block region is obstructed.

12. The method of claim 11, wherein the machine-learning model is configured for retraining using an updated training dataset, and wherein the updated training dataset includes at least one frame of the plurality of frames captured during the capturing step.

13. The method of claim 8, further comprising, prior to capturing the plurality of frames of the overhead area:
outputting an elevation indicator overlaying the user interface, wherein the elevation indicator is configured to indicate a predefined angle at which to tilt the mobile device prior to capturing the plurality of frames of the overhead area; and
subsequent to the mobile device being tilted at the predefined angle, providing, via the user interface, an interface element configured to be selected to initiate the capturing step.

14. The method of claim 8, wherein capturing the plurality of frames further comprises:
outputting, via the user interface, one or more graphical elements overlaying the field of view, wherein an amount of the one or more graphical elements is configured to indicate progress of the capturing step;
capturing a particular frame of the plurality of frames, wherein the particular frame corresponds to a subset of the one or more graphical elements;
in response to capturing the particular frame, removing a subset of the one or more graphical elements from the user interface; and
outputting a progress indicator corresponding to the subset of the one or more graphical elements removed from the user interface.

15. The method of claim 8, wherein the obstruction map further comprises a two-dimensional representation of the overhead area, azimuthal identifiers with respect to the two-dimensional representation, and cardinal direction indicators with respect to the two-dimensional representation, and wherein the two-dimensional representation includes a visual indicator configured to indicate a respective location of obstructions detected in the overhead area.

16. A computational system to determine availability of continuous communication with a satellite constellation, the computational system comprising:
a set of processors;
a non-transitory memory having instructions stored thereon, which, when executed, cause the set of processors to perform steps comprising using an augmented reality (AR) application installed on a mobile device to:
output, via a display of the mobile device, a user interface depicting a field of view being captured by a camera of the mobile device;
capture, via the camera of the mobile device, a plurality of frames of an overhead area through which the continuous communication with the satellite constellation is to be provided, the plurality of frames collectively mapping a 360-degree representation of the overhead area;
determine that the continuous communication with the satellite constellation is available using the plurality of frames; and
output, via the display, an obstruction map based on the plurality of frames that indicates open sky available for communication with the satellite constellation.

17. The computational system of claim 16, wherein the steps further comprise using the AR application to:
determine a recommendation with respect to installing an antenna for a user terminal based on a predefined threshold with respect to the open sky available for communication with the satellite constellation; and
output, via the user interface, the obstruction map, wherein the obstruction map comprises a visual indicator associated with the open sky available for communication with the satellite constellation and the recommendation.

18. The computational system of claim 17, wherein the predefined threshold with respect to the open sky available for communication with the satellite constellation is independent of an orientation of the antenna.

19. The computational system of claim 16, wherein determining that the continuous communication with the satellite constellation is available further comprises executing a machine-learning model to:
identify a block region of the plurality of frames, wherein the block region comprises a plurality of pixels;
determine that at least one pixel of the plurality of pixels includes an obstruction by performing image segmentation; and
assign an obstruction identifier to the block region associated with the at least one pixel, wherein the obstruction identifier indicates that the overhead area corresponding to the block region is obstructed.

20. The computational system of claim 16, wherein the steps further comprise using the AR application to, prior to capturing the plurality of frames of the overhead area:
output an elevation indicator overlaying the user interface, wherein the elevation indicator is configured to indicate a predefined angle at which to tilt the mobile device prior to capturing the plurality of frames of the overhead area; and
subsequent to the mobile device being tilted at the predefined angle, provide, via the user interface, an interface element configured to be selected to initiate the capturing step.
